(19) United States
(12) Patent Application Publication
(10) Pub. No.: US 2010/0244667 A1
(43) Pub. Date: Sep. 30, 2010

(54) Organic Light-Emitting Display Panel

(75) Inventors: Chun-Hao Pan, Tainan City (TW); Chung-Che Tsou, Taoyuan County (TW); Yi-Nan Tsai, Kaohsiung City (TW)

Correspondence Address: WPAT, PC;INTELLECTUAL PROPERTY ATTORNEYS, 2030 MAIN STREET, SUITE 1300, IRVINE, CA, 92614, US

(73) Assignee: RiTdisplay Corporation, Hsin Chu Industrial Park (TW)

(21) Appl. No.: 12/475,852

(22) Filed: Jun. 1, 2009

(30) Foreign Application Priority Data
Mar. 27, 2009 (TW) 098110162

(51) Int. Cl. H01J 1/62

(52) U.S. Cl. 313/504

(57) ABSTRACT

The invention discloses an organic light-emitting display panel, which includes a substrate, an electrode layer, a light-emitting layer, upper conductors and assistant electrodes. The electrode layer is disposed on the substrate. The light-emitting layer is disposed on the electrode layer. The light-emitting layer includes organic light-emitting units and isolation units. The organic light-emitting units are separately disposed on the electrode layer. The isolation units are disposed between the organic light-emitting units. The upper conductors are disposed on the light-emitting layer. The assistant electrodes are respectively disposed on the isolation units. Each assistant electrode is electrically connected with one of the upper conductors, so as to reduce the equivalent resistance of the upper conductor with the assistant electrode.

### BACKGROUND OF THE INVENTION

1. Field of the Invention

The invention relates to an organic light-emitting display panel and, more particularly, to a slim-shaped organic light-emitting diode based (OLED-based) display panel.

2. Description of the Prior Art

With the ever-developing technology of digital display, the slim-shaped display panels have become the main carriers of multimedia information in daily life. Especially, the TFT-LCD (thin film transistor liquid crystal display) is the mainstream of the electronic display application. The TFT-LCD utilizes a backlight module to emit light through the liquid crystal layer with diverse refraction rates, and it cooperates with optical filters with different colors to achieve the displaying effect.

The liquid crystal layer can not generate light by itself. Therefore, the LCD must implement the liquid crystal layer, the backlight module and corresponding driver circuit. The essential components need a certain space and a certain thickness, so the LCD can not be further slimmed down in this situation. Besides, the light generated by the backlight module only has a low optical extraction rate over the liquid crystal layer. It leads to a loss of the light-emitting efficiency.

In the optoelectronic application nowadays, the OLED (organic light-emitting diode) is emerged to be a possible solution. It is because that the OLED can generate light by itself. Compared with a traditional LCD, the organic light-emitting display panel formed by OLED components has advantages in fast response time, good light-emitting efficiency and compact size. In addition, the organic light-emitting display panel is not limited by the displaying angle issue, which is a bother in a LCD. A mini-sized organic light-emitting display panel may even provide better displaying experience. Please refer to FIG. 1. FIG. 1 is a top view diagram illustrating an organic light-emitting display panel 1 in prior art.

As shown in FIG. 1, the organic light-emitting display panel 1 includes a displaying area 10, a first pins area 12 and a second pin area 14. The first pin area 12 and the second pin area 14 are disposed to surround the displaying area 10 of the organic light-emitting display panel 1. In practical applications, there are vertical lower conductors WI and horizontal upper conductor W2 disposed within the displaying area 10. Each lower conductor W1 is coupled to the first pin area 12, and each upper conductor W2 is coupled to the second pin area 14.

When the organic light-emitting display panel 1 is active, a display signal can be transmitted from the first pin area 12 through the lower conductors W1 and the upper conductors W2, and then back to the second pin area 14. Accordingly, the display signal can drive organic light-emitting units disposed between the upper conductors W1 and the lower conductors W2.

Please refer to FIG. 2. FIG. 2 is a sectional view diagram illustrating the displaying area 10 of the organic light-emitting display panel 1 in FIG. 1 along X-X direction. As shown in FIG. 2, the displaying area 10 of the organic light-emitting display panel 1 includes a substrate 100, an electrode layer 102, a light-emitting layer 104 and an upper electrode layer 106, which are stacked from bottom to top. There are lower conductors W1 disposed within the electrode layer 102. There are organic light-emitting units 1040 and isolation units for separating the organic light-emitting units 1040 disposed within the light-emitting layer 104. There are upper conductors W2 disposed within the upper electrode layer 106.

In a practical case, the light of the organic light-emitting display panel 1 may be projected from its organic light-emitting units 1040 emitting the light toward the substrate 100, the substrate 100 and the electrode layer 102 may be implemented with a transparent material, e.g. the substrate 100 can a transparent substrate and the electrode layer 102 can be an ITO (indium tin oxide) transparent conductive-film. In this case, the upper conductors W2 must have high conductivity and low resistivity, to ensure even brightness and high optoelectronic conversion efficiency on the organic light-emitting display panel 1. In practical applications, the upper conductors W2 are usually metal wirings with certain thickness.

However, in the trend of slimming down the device sizes, all kinds of consumer-oriented electronic products aim to achieve various functions in most compact sizes. When the upper electrode layer in the organic light-emitting display panel 1 is designed to be a transparent or semi-transparent layer for double-sided light emitting function, it must adopt thinner upper conductors W2. In some other cases, when designers want to slim down the total thickness of the organic light-emitting display panel 1, designers may try to cut down the thickness of the upper conductors W2. However, that to reduce thickness of the upper conductors W2 in aforesaid cases may bring higher resistivity of the upper conductors W2 as a tradeoff.

In order to slim down the organic light-emitting display panel or to realize the transparent (or semi-transparent) upper electrode layer, and furthermore, to maintain even brightness and good display quality on the organic light-emitting display panel at the same time, it must consider both of thickness and resistivity while designing the upper conductors. The invention discloses an organic light-emitting display panel which can be implemented in a slim shape and can maintain a good electrical conductivity, so as to solve aforesaid problems.

### SUMMARY OF THE INVENTION

A scope of the invention is to provide an organic light-emitting display panel, which includes a substrate, an electrode layer, a light-emitting layer, upper conductors and assistant electrodes. The electrode layer is disposed on the substrate.

According to an embodiment, the light-emitting layer is disposed on the electrode layer, and the light-emitting layer includes organic light-emitting units and first isolation units. The organic light-emitting units are separately disposed on the electrode layer. The first isolation units are disposed on the electrode layer and located between the organic light-emitting units.

The upper conductors are disposed on the light-emitting layer. The assistant electrodes are disposed on the first isolation units. Each assistant electrode is connected with one of the upper conductors respectively. Accordingly, the assistant electrodes cooperate with the upper conductors for forming a lower equivalent resistivity.

The assistant electrodes, which are disposed on the first isolation units and connected with the upper conductors, can cooperate with the upper conductors and elevate its conductivity, such that the display error caused by high resistivity can be eliminated. In this way, the stability and displaying quality of the organic light-emitting display panel can be enhanced, and besides it allows more flexibility in designing the thickness of the upper conductors. On the other hand, the assistant electrodes disposed on the first isolation units will not block the light-projecting pattern of the organic light-emitting units, so it can ensure a better optical extraction rate no matter that the light is projected out through either one or both of the substrate and the upper electrode layer.

The advantage and spirit of the invention may be understood by the following recitations together with the appended drawings.

### BRIEF DESCRIPTION OF THE APPENDED DRAWINGS

FIG. 1 is a top view diagram illustrating an organic light-emitting display panel in prior art.

FIG. 2 is a sectional view diagram illustrating the displaying area of the organic light-emitting display panel in FIG. 1.

FIG. 3 is a top view diagram illustrating an organic light-emitting display panel according to an embodiment of the invention.

FIG. 4 is a sectional view diagram illustrating the displaying area of the organic light-emitting display panel in FIG. 3.

FIG. 5 is a sectional view diagram illustrating the second pin area of the organic light-emitting display panel in FIG. 3.

FIG. 6 is a sectional view diagram illustrating the second pin area of the organic light-emitting display panel in FIG. 3 according to another embodiment of the invention.

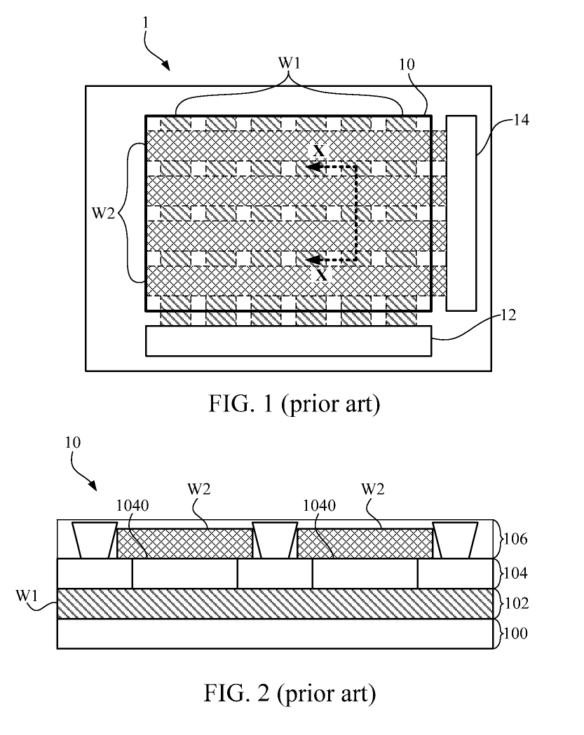

### DETAILED DESCRIPTION OF THE INVENTION

Please refer to FIG. 3. FIG. 3 is a top view diagram illustrating an organic light-emitting display panel 3 according to an embodiment of the invention. As shown in FIG. 3, the organic light-emitting display panel 3 includes a displaying area 30, a first pin area 32 and a second pin area 34. The first pin area 32 and the second pin area 34 are disposed to surround the displaying area 30 of the organic light-emitting display panel 3. In the embodiment, the second pin area 34 is disposed on the right side of the displaying area 30, but not limited to this. In another embodiment, the second pin area 34 can also be disposed on the left side or on both sides relative to the displaying area 30.

In practical applications, the first pin area 32 may include a plurality of first pins 320, and the second pin area 34 may include a plurality of second pins 340. There may be a plurality of lower conductors W1 along a first direction and a plurality of upper conductors W2 along a second direction disposed within the displaying area 30. In the embodiment, the lower conductors W1 extend vertically and the upper conductors W2 extend horizontally, as shown in FIG. 3. Each lower conductor W1 is electrically connected to one of the first pins 320 correspondingly. Each upper conductor W2 is electrically connected to one of the second pins 340 correspondingly. Corresponding to each combination of lower conductors W1 and the upper conductors W2, there is one of organic light-emitting units disposed in-between. The arrangement of the upper conductors W1 and the lower conductors W2 is based on the signal demanding of pixels on the organic light-emitting display panel 3.

When the organic light-emitting display panel 3 is active, a display signal can be transmitted from the first pin area 32 through the lower conductors W1 and the upper conductors W2, and then back to the second pin area 34. Accordingly, the display signal can drive organic light-emitting units disposed between the upper conductors W1 and the lower conductors W2. The brightness, chrominance or other displaying configuration of each pixel can be adjusted by tuning the voltage of the display signal.

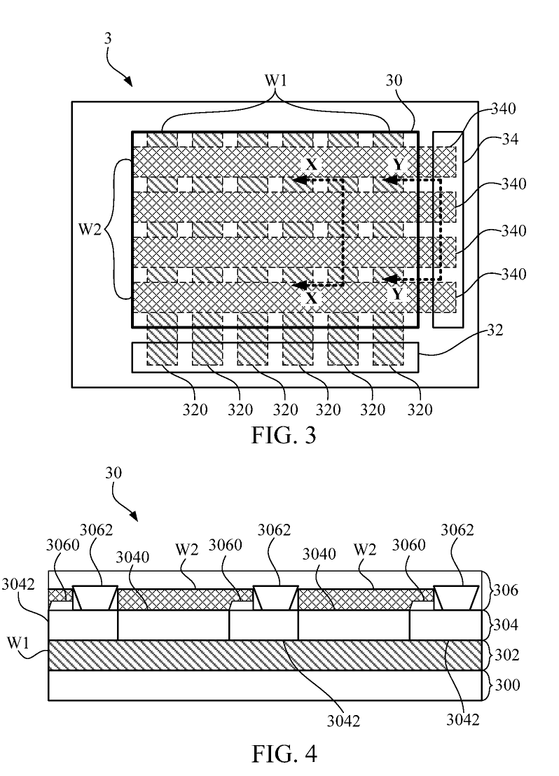

Please refer to FIG. 4. FIG. 4 is a sectional view diagram illustrating the displaying area of the organic light-emitting display panel 3 in FIG. 3 along X-X direction. As shown in FIG. 4, the displaying area 30 of the organic light-emitting display panel 3 includes a substrate 300, an electrode layer 302, a light-emitting layer 304 and an upper electrode layer 306. The electrode layer 302, which is disposed on the substrate 300, includes lower conductors W1. The light-emitting layer 304, which is disposed on the electrode layer 302, includes organic light-emitting units 3040 and isolation units 3042. The upper electrode layer 306, which is disposed on the light-emitting layer 304, includes upper conductors W2, assistant electrodes 3060 and isolation structures 3062.

As shown in FIG. 4, in the light-emitting layer 304 of the organic light-emitting display panel 3 in the embodiment, the organic light-emitting units 3040 are respectively located above the lower conductors W1 of the electrode layer 302, and the organic light-emitting units 3040 are separately disposed on the electrode layer 302. The first isolation units 3042 are disposed on the electrode layer. The first isolation units 3042 are located between the organic light-emitting units 3040 for isolating and separating different organic light-emitting units 3040, so to define different pixels.

In the embodiment, the electrode layer 302 may further includes second isolation units (not shown) disposed between the lower conductors W1 along the vertical direction, for isolating and separating the lower conductors W1.

As shown in FIG. 4, in the upper electrode layer 306 of the organic light-emitting display panel 3 in the embodiment, each upper conductor W2 is respectively disposed above one of the organic light-emitting units 3040 of the light-emitting layer 304. Besides, each assistant electrode 3060 is respectively disposed above one of the first isolation units 3042 of the light-emitting layer 304. Each assistant electrode 3060 is connected with one of the upper conductors W2. The assistant electrodes 3060 can be trapezoid shapes with bottom angles under 90° respectively (shown in FIG. 4). Each separation structure 3062 is respectively disposed on one of the first isolation unit 3042 and between the upper conductors W2, and used for separating the upper conductors W2. The separation structures 3062 can be reverse-trapezoid shapes with bottom angles over 90° respectively.

The assistant electrodes 3060 are made of one or a compound with at least two selected from a group of Al, Au, Ag, Ti, Cr, Mo and Cu. In other words, the assistant electrodes 3060 are made of conductive material with high conductivity and low resistivity. In the embodiment, the conductivity of the assistant electrodes 3060 is greater than the conductivity of the upper conductors W2. The assistant electrodes 3060 in the embodiment are disposed to cooperate with the upper conductors W2 for forming a lower equivalent resistivity. Accordingly, designers are allowed to adopt thinner upper conductors W2 in the organic light-emitting display panel 3 compared to the traditional structure, such that the overall size of the organic light-emitting display panel 3 can be slimmed down.

In this embodiment, the lower conductors W1 can be made of an ITO material or a transparent conductive material. The substrate 300 can be a transparent substrate. Accordingly, light generated by the organic light-emitting units 3040 can go through the electrode layer 302 and be projected out through the substrate 300, but the invention is not limited to this light-projecting pattern.

The organic light-emitting display panel 3 according to the invention may have slim-sized upper conductors. Therefore, the upper conductors W2 above the organic light-emitting unit 3040 can be transparent or semi-transparent. In other words, the light generated by the organic light-emitting unit 3040 may go through the upper electrode layer 306, such that the organic light-emitting display panel 3 can project light along different directions or it can project bi-directional light.

In practical producing process, the first pin area 32 and the second pin area 34 of the organic light-emitting display panel 3 in the embodiment are usually implemented in a process similar to one of the displaying area 30. In other words, the first pins 320 of the first pin area 32 and the second pins 340 of the second pin area 34 may be formed in a structure similar to the displaying area 34.

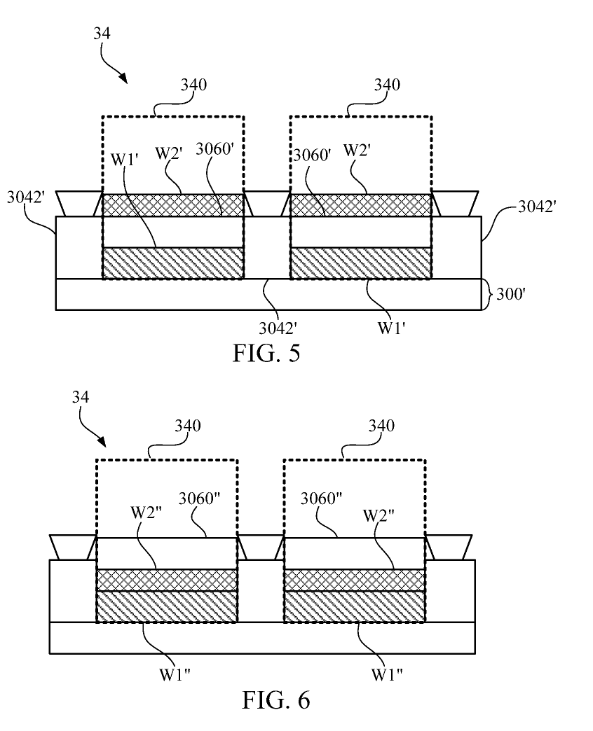

Please refer to FIG. 5 as well. FIG. 5 is a sectional view diagram illustrating the second pin area 34 of the organic light-emitting display panel 3 in FIG. 3 along Y-Y direction. As shown in FIG. 5, each of the second pins includes a lower conductor layer W1′, an assistant electrode layer 3060′ and an upper conductor layer W2′. The lower conductor layer W1′ is disposed on the substrate 300′ of the second pin area 34. The assistant electrode layer 3060′ is disposed on the lower conductor layer W1′. The upper conductor layer W2′ is disposed on the assistant electrode layer 3060′. The lower conductor layer W1′, the upper conductor layer W2′ and the assistant electrode layer 3060′ are used for transmitting the display signal together.

In the second pin area 34 of the embodiment, the lower conductor layers W1′, the assistant electrode layers 3060′ and the upper conductor layers W2′ can be respectively formed in one piece with the lower conductors W1, the assistant electrodes 3060 and the upper conductors W2 in the displaying area 30 (please refer to FIG. 3 and FIG. 4).

Besides, the organic light-emitting display panel 3 in the invention further includes fourth isolation units 3042′ (shown in FIG. 5) disposed between the second pins 340, for isolating and separating the second pins 340. On the other hand, the organic light-emitting display panel 3 may further includes third isolation units (not shown) disposed between the first pins.

Furthermore, the arrangement of the lower conductor layers W1′, the assistant electrode layers 3060′ and the upper conductor layers W2′ in the second pins 340 is not limited to the aforesaid example. Please refer to FIG. 6 as well. FIG. 6 is a sectional view diagram illustrating the second pin area 34 of the organic light-emitting display panel 3 in FIG. 3 along Y-Y direction according to another embodiment of the invention. As shown in FIG. 6, each of the second pins 340 may include a lower conductor layer W1″, an upper conductor layer W2″ and an assistant electrode layer 3060″, which are stacked from bottom to top. The lower conductor layer W1″, the upper conductor layer W2″ and the assistant electrode layer 3060″ are used for transmitting the display signal together. In other words, the exact position of the assistant electrode layer 3060″ can be decided according to the practical producing process.

In summary, the assistant electrodes, which are disposed on the first isolation units and connected with the upper conductors, can cooperate with the upper conductors and elevate its conductivity, such that the display error caused by high resistivity can be eliminated. In this way, the stability and displaying quality of the organic light-emitting display panel can be enhanced, and besides it allows more flexibility in designing the thickness of the upper conductors. On the other hand, the assistant electrodes disposed on the first isolation units will not block the light-projecting pattern of the organic light-emitting units, so it can ensure a better optical extraction rate no matter that the light is projected out through either one or both of the substrate and the upper electrode layer.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An organic light-emitting display panel, comprising:
a substrate;
an electrode layer disposed on the substrate;
a light-emitting layer disposed on the electrode layer, the light-emitting layer comprising:
a plurality of organic light-emitting units, the organic light-emitting units being separately disposed on the electrode layer; and
a plurality of first isolation units disposed on the electrode layer, the first isolation units being located between the organic light-emitting units;
a plurality of upper conductors disposed on the light-emitting layer; and
a plurality of assistant electrodes disposed on the first isolation units, each assistant electrode being connected with one of the upper conductors, the assistant electrodes cooperating with the upper conductors for forming a lower equivalent resistivity.

2. The organic light-emitting display panel of claim 1, wherein the electrode layer comprises a plurality of lower conductors, each lower conductor extends along a first direction, each upper conductor extends along a second direction, and each organic light-emitting unit is located between one of the lower conductors and one of the upper conductors.

3. The organic light-emitting display panel of claim 2, wherein the electrode layer further comprises:
a plurality of second isolation units respectively disposed between the lower conductors for isolating and separating the lower conductors.

4. The organic light-emitting display panel of claim 2, further comprising:
a plurality of separation structures respectively disposed on the first isolation units and between the upper conductors for separating the upper conductors.

5. The organic light-emitting display panel of claim 4, wherein the separation structures are reverse-trapezoid shapes with bottom angles over 90° respectively.

6. The organic light-emitting display panel of claim 2, further comprising a plurality of first pins, a plurality of second pins, a plurality of third isolation units and a plurality of fourth isolation units, the first pins being electrically connected to the lower conductors correspondingly, the second pins being electrically connected to the upper conductors correspondingly, the third isolation units being disposed between the first pins, the fourth isolation units being disposed between the second pins.

7. The organic light-emitting display panel of claim 6, wherein each of the second pins comprises:
a lower conductor layer disposed on the substrate;
an upper conductor layer disposed on the lower conductor layer; and
an assistant electrode layer disposed on the upper conductor layer, the lower conductor layer, the upper conductor layer and the assistant electrode layer being used for transmitting a display signal together.

8. The organic light-emitting display panel of claim 7, wherein the lower conductor layers, the upper conductor layers and the assistant electrode layers of the second pins are respectively formed in one piece with the lower conductors, the upper conductors and the assistant electrodes.

9. The organic light-emitting display panel of claim 6, wherein each of the second pins comprises:
a lower conductor layer disposed on the substrate;
an assistant electrode layer disposed on the lower conductor layer; and
an upper conductor layer disposed on the assistant electrode layer, the lower conductor layer, the upper conductor layer and the assistant electrode layer being used for transmitting a display signal together.

10. The organic light-emitting display panel of claim 9, wherein the lower conductor layers, the upper conductor layers and the assistant electrode layers of the second pins are respectively formed in one piece with the lower conductors, the upper conductors and the assistant electrodes.

11. The organic light-emitting display panel of claim 2, wherein the lower conductors are made of an ITO material or a transparent conductive material.

12. The organic light-emitting display panel of claim 1, wherein the assistant electrodes are trapezoid shapes with bottom angles under 90° respectively.

13. The organic light-emitting display panel of claim 1, wherein a first conductive index of the assistant electrodes is larger than a second conductive index of the upper conductor.

14. The organic light-emitting display panel of claim 13, wherein the assistant electrodes are made of one or a compound with at least two selected from a group of Al, Au, Ag, Ti, Cr, Mo and Cu.

15. The organic light-emitting display panel of claim 1, wherein the substrate is a transparent substrate.
